(19) United States
(12) Patent Application Publication
(10) Pub. No.: US 2008/0311843 A1
(43) Pub. Date: Dec. 18, 2008

(54) Satellite Radio Advertisement System and Method

(76) Inventors: Richard O. Freij, East Lansing, MI (US); Randall M. Freij, East Lansing, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/764,016

(22) Filed: Jun. 15, 2007

(51) Int. Cl. H04H 20/74

(52) U.S. Cl. 455/3.02

(57) ABSTRACT

A satellite radio system includes a satellite receiver receiving audio programming and an advertising packet including a plurality of visual advertisements. The satellite radio system further includes a computer controlling the display of the visual advertisements on the display as the audio programming is being played over a speaker. The visual advertisements are displayed one at a time on the display and them marked “used.” When a threshold number of the visual advertisements have been displayed, a new advertising packet is downloaded.

### BACKGROUND OF THE INVENTION

The present invention relates generally to advertising methods and more particularly to a method of displaying advertisements on a satellite radio.

Satellite radios are well known. A satellite radio provider, e.g., Sirius or XM Radio, transmits commercial free radio broadcasts to consumers. The providers' satellite radio ground stations route radio signals to an orbiting satellite. The satellite then transmits the signals to individual receivers on the ground. Typically, the receivers are contained within satellite radio units, which are installed in vehicles or operate as handheld units. A consumer purchases the satellite radio units and also pays a monthly subscription fee to the satellite radio provider to receive satellite radio programming. The amount of the monthly fee and the type of subscription determine the satellite radio programming the consumer receives.

Satellite radio programming includes music channels, talk radio channels, and television station audio. Satellite radio channels typically broadcast commercial free, that is, the programming is uninterrupted by audio advertisements. Some satellite radio channels, e.g., talk radio channels, may incorporate audio advertisements to generate revenue. For example, a corporation may pay the satellite radio provider for a thirty-second block of time in which to advertise. Although audio advertisements are used, satellite radio providers rely primarily on the monthly subscription fee paid by the consumer to generate the majority of their revenue. In addition, a selling point of satellite radios is providing programming uninterrupted by audio advertisements.

Satellite radios are particularly prevalent in vehicles and may be standard equipment on some vehicle models. Other vehicles choose to include satellite radios as a factory or dealer installed option. The satellite radios typically contain a display screen, which visually indicates the satellite radio station. The display screen may also include interactive controls. For instance, the display screen may be a touch screen and may contain controls for tuning the satellite radio stations or adjusting the volume. Thus, the user may observe and interact with the display screen without interrupting the audio programming. However, the display screen is not used to generate revenue for the satellite radio provider.

### SUMMARY OF THE INVENTION

A satellite radio system includes a satellite receiver receiving audio programming and an advertising packet including a plurality of visual advertisements. The satellite radio system further includes a computer controlling the display of the visual advertisements on the display as the audio programming is being played over a speaker. The visual advertisements are displayed one at a time on the display and them marked “used.” When a threshold number of the visual advertisements have been displayed, a new advertising packet is downloaded.

These and other features of the present invention can be best understood from the following specification and drawings, the following of which is a brief description.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of a satellite radio system.

FIG. 2 is an enlarged view of a typical satellite radio display screen.

FIG. 3 is a schematic of the revenue flow between the advertiser and the satellite radio provider.

### DETAILED DESCRIPTION OF THE PREFERRED EMBODIMENT

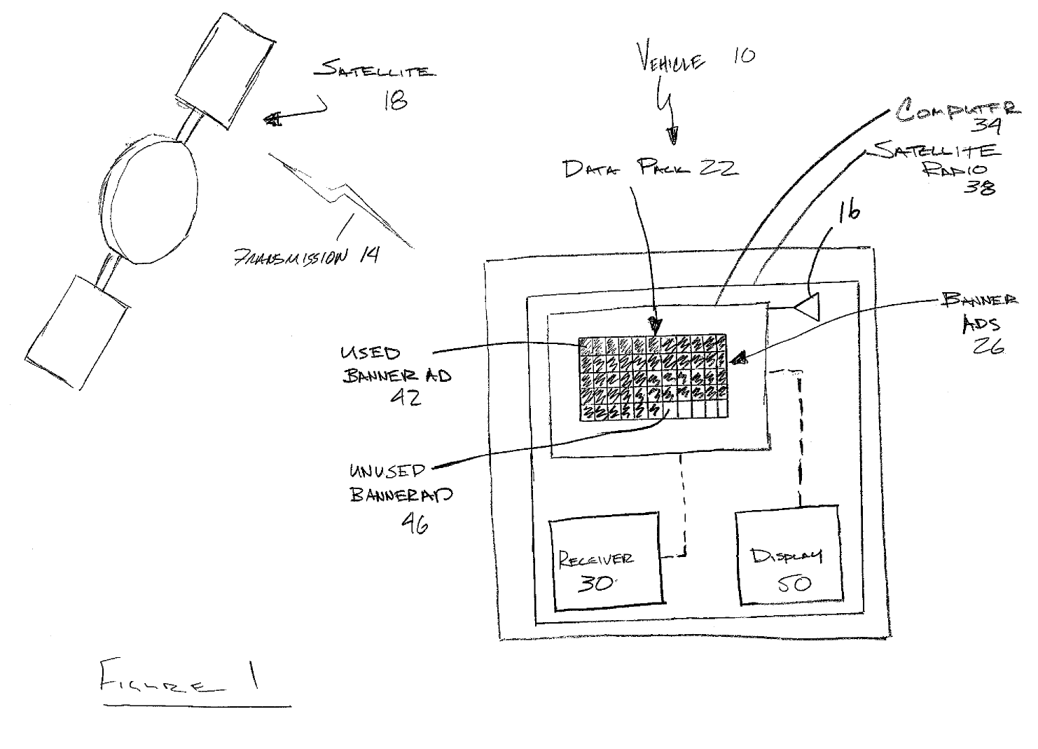

Referring to FIG. 1, a satellite radio 38 includes a receiver 30 for receiving satellite signals, a computer 34 for converting, storing and processing the satellite signals, a speaker 16 for playing audio programming, and a display 50 as part of a user interface for controlling the satellite radio 38. The satellite radio 38 is shown (schematically) installed in a vehicle 10, but the present invention would be applicable to handheld, portable or home satellite radio 38 as well.

The satellite receiver 30 receives a transmission 14 from a satellite 18. The transmission 14 includes the satellite radio audio programming and a data pack 22 having a multitude of banner ads 26. The receiver 30 accepts the transmission 14 from the satellite 18 and communicates the transmission 14 to the computer 34 within the satellite radio 38. The computer 34 routes the banner ads 26 to the display 50 whereupon a person, such as a driver or passenger in the vehicle 10, may view the banner ad 26.

Although the present example discloses the data pack 22 having the multitude of banner ads 26, those skilled in the art and having the benefit of this disclosure will understand that the data pack 22 may include a single ad. Such an example requires the transmission 14 between the satellite 18 and the receiver 30 before displaying a different ad. Thus, the satellite 18 may stream the communication of the multitude of banner ads 26 to the receiver 30 instead of the multitude of banner ads 26 arriving in the data pack 22.

In addition to the banner ads 26, the receiver 30 of the satellite radio 38 also receives programming from the satellite 18. The user controls the programming by tuning the satellite radio 38 to a desired station. The computer 34 within the satellite radio 38 controls the display of the banner ads 26 either independently or dependently upon the programming selected by the user.

The computer 34 may control the display of the banner ads 26 in various ways. In one embodiment, the computer 34 displays banner ads 26 based upon the satellite radio stations selected by the user. For example, when the user tunes the satellite radio 38 to a country music station, advertisements are played which appeal to that demographic. In another embodiment, the computer 34 displays the banner ads 26 sequentially, such that, the banner ads 26 are displayed independently of current station. For example, the user will view the same sequence of banner ads 26 regardless of the station the user is tuned to.

Referring to the data pack 22 of FIG. 1, when first stored on the computer 34, the banner ads 26 are all classified as unused banner ads 26. As each banner ad 26 is displayed, the computer 34 reclassifies the banner ad 26 as a used banner ad 42. Thus, the computer 34 tracks the banner ads 46 that have been displayed. In so doing, the computer 34 allows only the banner ads 26 classified as unused banner ads 46 to be displayed.

The computer 34 also tracks the percentage of used banner ads 42 within the data pack 22. In the presently preferred embodiment, the satellite radio 38 receives the data pack 22 of unused banner ads 46 when approximately 90% of the banner ads 26 in the existing data pack 22 are classified as used banner ads 42. This approach prevents a delay in displaying unused banner ad 46 due to interruptions in the transmission 14 of the data pack 22 from the satellite 18.

Once an unused banner ad 46 is transmitted to the display 50 the unused banner ad 46 is reclassified as a used banner ad 42. The computer 34 displays the unused banner ad 46 on the display for a period of time before removing the banner ad 26 from the display 50. Alternatively, the computer 34 may display the banner ad 26 until the user prompts the computer 34 to remove the banner ad 26 from the display 50. Also, the computer 34 ensures that each of the banner ads 26 is displayed only when the system is on (and, presumably, the user is present). Unlike normal audio advertisements, which will play whether or not the user's radio is on, the banner ads 26 wait until the satellite receive 30 and display 50 is on to display each banner ad 26.

The data pack 22 is typically transmitted to the receiver 30 when the user starts the vehicle 10. When a data pack 22 is being transmitted from the satellite 18 or otherwise cannot be accessed, the display 50 will display a message indicating that the data pack 22 is loading.

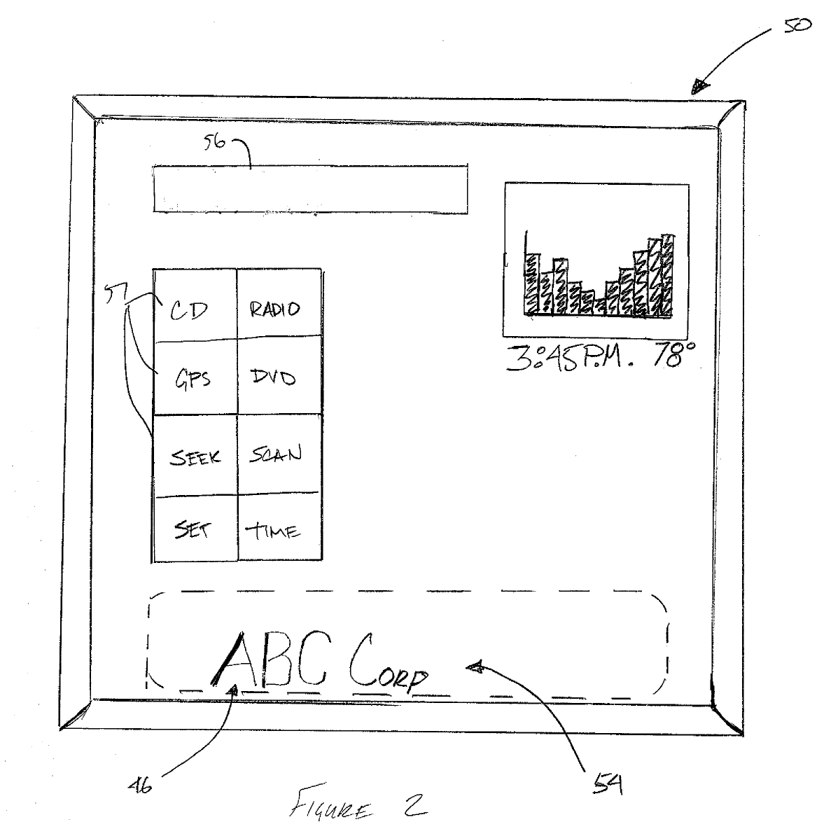

The computer 34 accepts the data pack 22 and transmits unused banner ads 46 to a display area 54 of the display 50, as shown in FIG. 2. The display 50 also displays source ID 56 indicating a selected satellite-programming channel (or radio station, or CD track information, etc. for a display 50 that provides information for multiple systems). The display 50 may also display touch-screen buttons 57 that control the operation of the satellite receiver 30 (FIG. 1) and/or other entertainment/communication systems. The banner ad 26 is a visual advertisement which may include some motion. As the banner ad 26 is visual, the audio programming may continue uninterrupted from the satellite radio 38 while the banner ad 26 is displayed.

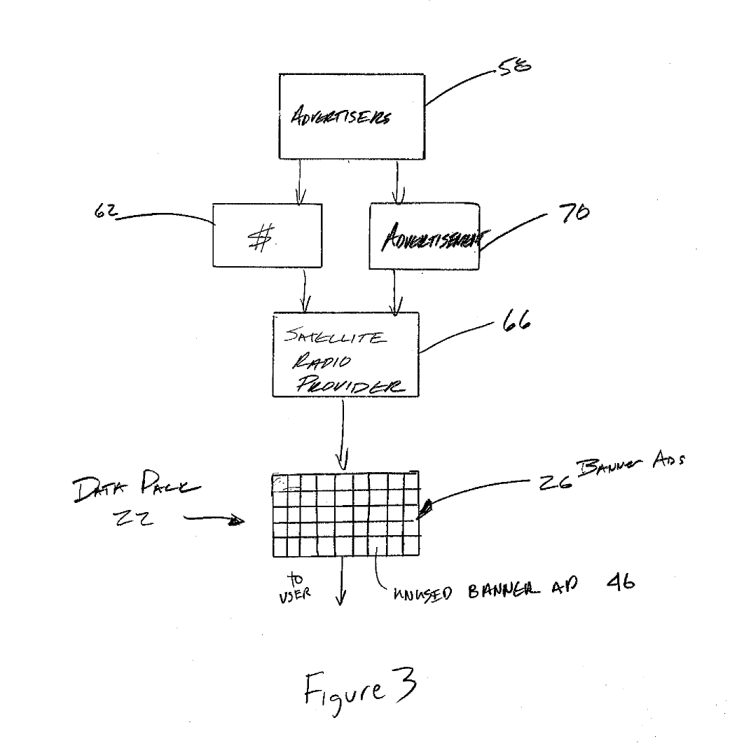

As shown in FIG. 3, the banner ad 26 is displayed in an advertising area 54 of the display 50. The advertisers 58, such as major corporations, pay a fee to a satellite provider 66, generating revenue 62 for the satellite provider 66 who then includes an advertisement 70 from the advertiser 58 within the banner ads 26 in the data pack 22. Thus, the satellite provider 66 generates revenue 62 without interrupting audio programming or increasing user fees.

In addition to the advertising area 54 of the display 50 displaying the banner ads 26, the advertising area 54 as shown in FIG. 2 may also display other information. For instance, news organizations may utilize the advertising area 54 to display news or sports updates. These updates would be delivered via data pack 22 from the satellite 18. The news organizations would display their information after paying a fee to the satellite provider 66. Thus, the satellite provider 66 generates additional revenue 62 without increasing an user's monthly subscription cost.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1) A method of displaying information on a satellite radio comprising:
compiling visual advertisements into a data pack;
transmitting said data pack to a satellite radio; and
displaying said visual advertisements on a satellite radio display screen.

2) The method of claim 1, including charging a fee for transmitting said visual advertisements.

3) The method of claim 1, wherein said visual advertisements are banner ads.

4) The method of claim 3, including the step of displaying said banner ads sequentially.

5) The method of claim 3, including the step of displaying said banner ads based on a user input.

6) A satellite radio system comprising:
a satellite provider delivering radio programming and visual advertisements to a satellite radio;
a radio display having a first designated area and a second designated area, wherein information relating to said radio programming is displayed on said first designated area and said visual advertisements are displayed on said second designated area; and
wherein said visual advertisements are displayed independently of said radio programming.

7) The satellite radio system of claim 6, wherein said visual advertisements include banner ads.

8) The satellite radio system of claim 6, wherein said visual advertisements are scrolling advertisements.

9) The satellite radio system of claim 6, wherein a plurality of said visual advertisements are grouped as an advertising packet for delivery to said satellite radio.

10) The satellite radio system of claim 9, wherein said visual advertisements are extracted from said advertising packet and displayed on said second area.

11) The satellite radio system of claim 10, wherein said visual advertisements are sequentially displayed on said second area.

12) The satellite radio system of claim 10, wherein said visual advertisements are marked as displayed after being displayed on said second area.

13) The satellite radio system of claim 12, wherein a new advertising packet is delivered to said satellite radio after a predetermined number of visual advertisements in the existing advertising packet have been displayed.

14) A satellite radio receiver system comprising:
a satellite receiver for receiving satellite signals containing audio programming and visual advertisements;
storage for a plurality of said visual advertisements received from the satellite receiver; and
a radio display having a first designated area and a second designated area, wherein information relating to said audio programming is displayed on said first designated area and said visual advertisements are displayed on said second designated area.

15) The satellite radio system of claim 14 wherein said visual advertisements are displayed independently of said audio programming.

16) The satellite radio system of claim 14 wherein the plurality of said visual advertisements are grouped as an advertising packet for delivery through the satellite receiver to said storage.

17) The satellite radio system of claim 16, wherein said plurality of visual advertisements are extracted from said advertising packet and displayed on said second area.
